(19) United States
(12) Patent Application Publication
(10) Pub. No.: US 2008/0082401 A1
(43) Pub. Date: Apr. 3, 2008

(54) Consumer Portable Media Device

(76) Inventor: Glenn French, Portland, OR (US)

Correspondence Address: JOSEPH P. CURTIN, 1469 N.W. MORGAN LANE, PORTLAND, OR, 97229, US

(21) Appl. No.: 11/466,447

(22) Filed: Aug. 22, 2006

(51) Int. Cl. G06Q 30/00

(52) U.S. Cl. 705/14

(57) ABSTRACT

A display container having a media output device, such as a display and/or an audio output device and/or a Braille output device, presents information, such as a movie trailer. A controller is coupled to the media output device. The controller accesses predetermined media content in response to a start event, such as movement of the display container, actuation of a button coupled to the controller, sensed heat, motion and/or light changes, or by a touch to a touch-screen device, and causes the media output device to output the predetermined media content.

### BACKGROUND

The subject matter disclosed herein relates to product display system. More particularly, the subject matter disclosed herein relates to consumer portable media device that provides a potential customer with viewable information about a product and/or service.

Video rental stores stock a wide range of movie titles in order to cater to different viewing tastes. More obscure-titled movies would be rented if more information were available to potential customers rather than just the information printed on the DVD or VCR tape jacket.

A similar situation exists in retail stores in which a potential customer has a multitude of different products and/or services from which to choose. If the customer had easy access to viewable video information about a particular product and/or service, the chances that the customer would chose to rent or purchase that product and/or service would be increased.

Yet another environment in which information is needed for helping a user is a transportation environment, such as buses, airplanes, trains, ferries and taxis. People who are unfamiliar with a transportation system may need information for conveniently determining such information as the correct stop, obtain safety information, etc.

Consequently, what is needed is a way to provide potential customers with viewable video information to help in making a selection for renting or purchasing a product and/or a service. Further, what is needed is a way to provide people using a transportation system with information such as their location, their correct stop and safety information.

### BRIEF SUMMARY

The subject matter disclosed herein provides a way to provide potential customers more information to help in making a selection for renting or purchasing a product and/or a service. The subject matter disclosed herein also provides a way to provide people using a transportation system with information such as their location, their correct stop and safety information.

The advantages of the subject matter disclosed herein are provided by a consumer portable media device having a media output device, such as a display and/or an audio output device like a speaker or a pair of head phones, and/or a Braille output device, and a controller coupled to the media output device. The controller accesses predetermined media content in response to a start event, such as movement of the display container or actuation of a button coupled to the controller, and causes the media output device to output the predetermined media content. The start event can also be sensed by a heat, a motion and/or a light sensor or caused by a touch to a touch-screen device. The predetermined media content can include viewable information and audio information. The predetermined media content can also be transportation system infrastructure-based information. In particular, the media content can be a movie trailer, or information relating to a product and/or a service. One embodiment of the subject matter disclosed herein includes a DVD player that is coupled to and is controlled by the controller to access the predetermined media content, which is contained on a DVD. Another embodiment of the subject matter disclosed herein includes a VCR player that is coupled to and is controlled by the controller to access the predetermined media content, which is contained on a VCR tape. Yet another embodiment of the subject matter disclosed herein includes an audio CD player that is coupled to and is controlled by the controller to access the predetermined media content, which is contained on an audio CD. Still another embodiment of the subject matter disclosed herein includes an audio tape player that is coupled to and is controlled by the controller to access the predetermined media content, which is contained on an audio tape. The display container of the subject matter disclosed herein can include a memory that stores the predetermined media content, and an interface device that is coupled to the controller. The memory can be a hard disk drive, a flash memory, a random access memory, a read-only memory, a CD-flash card, a memory stick, a palm memory, a smart memory a CD-ROM and/or a DVD-ROM. The predetermined media content is received through the interface device and is stored in the memory under control of the controller. The predetermined media content can be received using a protocol that is based on an IEEE 802.11a/b/g protocol, a protocol that is based on a Bluetooth protocol and/or a packet-based protocol.

### BRIEF DESCRIPTION OF THE DRAWINGS

The subject matter disclosed herein is illustrated by way of example and not by limitation in the accompanying figures in which like reference numerals indicate similar elements and in which:

FIG. 1 shows an exemplary functional block diagram of a consumer portable media device according to the subject matter disclosed herein;

FIG. 2 shows a front perspective view of an exemplary embodiment of a consumer portable media device that is capable of displaying a movie trailer according to the subject matter disclosed herein; and

FIG. 3 shows a functional block diagram of the exemplary embodiment of consumer portable media device according to the subject matter disclosed herein.

### DETAILED DESCRIPTION

It should be understood that the word “exemplary” is used herein to mean “serving as an example, instance, or illustration.” Any embodiment described herein as “exemplary” is not necessarily to be construed as preferred or advantageous over other embodiments.

The subject matter disclosed herein provides a consumer portable media device, or display container, having audio and/or video playback capability for presenting locally stored or remotely stored information to a user, thereby assisting the user in making more informed decisions about products and/or services that are available through an interactive access to information. When the media device is activated, information is presented to a user through, for example, a speaker and/or a headphone jack and/or a small display and/or a Braille display device that are integrated into a small box-like housing or container that preferably ranges in size from about the size of a cassette tape to about the size of a VHS tape depending on the number of media display features that are provided. The information is stored in a static storage contained in the media device, in a storage device that is removable from the media device and/or transmitted to the media device from a remote storage.

The media device of the subject matter disclosed herein can, for example, be placed on a display shelf in a retail environment and when a shopper picks the media device up from the shelf, the media device is activated by the motion and begins to present, for example, product information and/or instruction information, to the shopper. Alternatively, the media device can be attached to a retail display case and be activated by a button that is pressed by a shopper, by a heat and/or a light and/or sound sensor that senses the proximity of a shopper, and/or by a shopper touching a touch-screen device.

Another exemplary use for a media device of the subject matter disclosed herein is to display movie trailer information in a video rental store. A media device could be placed on a video display shelf for each movie so the movie trailer for the movie can be viewed by customer is considering viewing the movie at home. As another example, a media device can be obtained when a customer enters the video rental store. When the customer wishes to view a particular movie trailer, the customer uses a scanner in proximity to a display of the desired movie to read, for example, a barcode or a UPC-type code that uniquely identifies the media device. A remote storage is then accessed by a central database of movie trailers that provides the movie trailer information to the media device for presentation. Alternatively, the media device can include a scanner that used for reading, for example, a barcode or a UPC-type code that identifies the desired movie. The media device then transmits the scanned information to a central database, which provides the movie trailer information to the media device for presentation. Yet another alternative provides at least one media device located, for example, at the end of an aisle. The media device contains a scanner that reads for example, a barcode or a UPC-type code that is provided on a VCR or a DVD case identifying a particular movie. When a movie case is scanned, a central database of movie trailers is accessed and the desired movie trailer is presented.

Another exemplary use of the media device of the subject matter disclosed herein is for a consumer to scan products for purchase by using a scanner on the media device to scan, for example, a barcode or a UPC-type code that is associated with a product. Information relating to the product is then presented to the consumer with an option to purchase the product. If the consumer elects to purchase the product, the product is retrieved and placed with other products that the consumer has elected to purchase. Product and purchase information is communicated to and from the media device via well-known RF and/or infrared communication techniques. After paying for the items, the consumer would then receive the items that were selected for purchase. Still another exemplary use for a media device according to the subject matter disclosed herein is for displaying safety, general and/or location information on, such as airplanes, buses, taxis, ferries, subways, trains, or wherever general information may be needed.

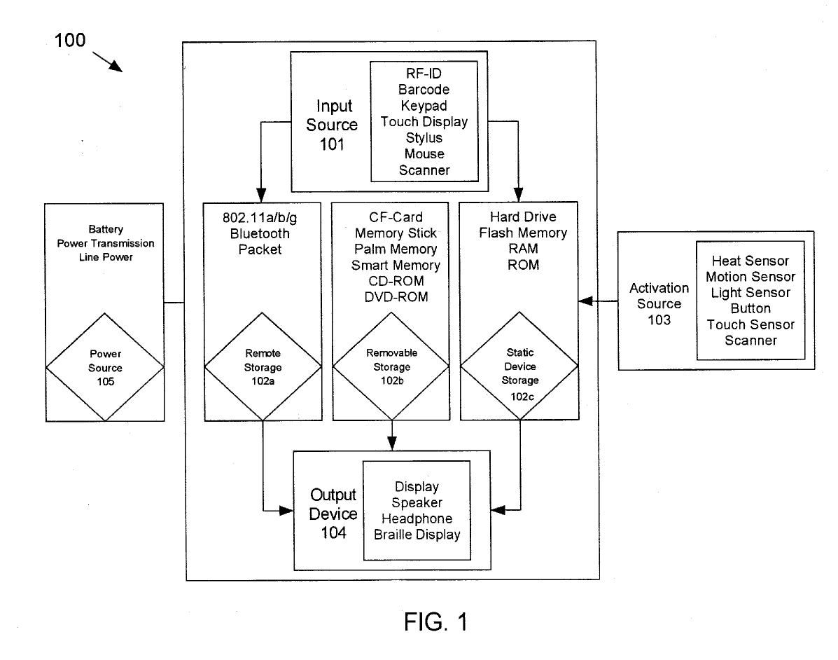

FIG. 1 shows an exemplary functional block diagram of a consumer portable media device 100 according to the subject matter disclosed herein. Media device 100 includes an input source 101, media storage 102, a media activation source 103, an output device 104 and a power source 105. Input source 101 can be at least one of an RF link that identifies media device 100 using, for example, well-known RF-ID techniques, a barcode or a UPC-type code that identifies media source 101, a keypad through which a user enters media identification information, a touch display, a stylus, a mouse and/or a scanner that is used for identifying the media device. Media storage 102 can be a remote storage 102a, a removable storage 102b and/or a static device storage 102c. Remote storage 102a can be accessed by media device 100 via a wireless communications protocol, such as the IEEE 802.11 a/b/g, Bluetooth protocol and/or using well-known packet communications protocol. Removable storage 102b can include a compact flash (CF) card, a memory stick, a palm memory, a smart memory, a CD-ROM and/or a DVD-ROM. Static device memory 102c can include a Hard Disk Drive (HDD), a flash memory, a Random-Access Memory (RAM) and/or a Read-Only Memory (ROM). Activation source 103 can be a heat sensor, a motion sensor, a light sensor, a button, a touch sensor and/or a scanner that reads a barcode or a UPC-type code that particularly identifies media that is to be presented. Output device 104 can be a display that is viewable by one or two persons, a speaker, a headphone and/or a Braille pad, such as disclosed by U.S. Pat. No. 6,542,643 B1 to Kahn or U.S. Pat. No. 6,417,821 B1 to Becker et al. Power source 105 can be a battery, a power transmission system and/or line power.

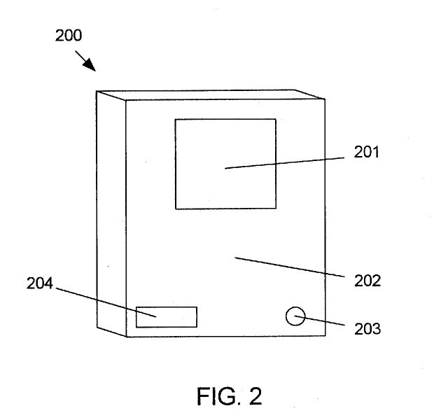

FIG. 2 shows an exemplary front perspective view of a first exemplary embodiment of a consumer portable media device 200 that is capable of displaying a movie trailer according to the subject matter disclosed herein. Media device 200 includes a display 201, such as an LCD display, and a movie title area 202. Movie title area contains printed information relating to a selected movie. A person who may be interested in renting the movie can view a trailer of the movie on display 201. Media device 200 can be any size, but is preferably about the size of a DVD rental container. Additionally, while display 201 is shown in FIG. 2 as having a particular size with respect to the overall size of media device 200, display 201 can be any convenient size.

In the first exemplary embodiment, media device 200 senses when it has been picked up and automatically displays the movie trailer. Alternatively, media device 200 can include a button 203 that a person can press to begin viewing the movie trailer. As yet other alternatives, media device 200 can be activated a user is sensed in proximity to media device 200 by a heat sensor and/or a light sensor and/or activated by a user touching a touch-screen display using a finger or a stylus. For all alternative embodiments, media device 200 contains the displayable movie trailer information in a memory that is part of media device 200. The first exemplary embodiment of media device 200 includes a memory that stores viewable movie trailer information for display on display 201 and an interface that can be used for changing the contents of the memory. Alternatively, media device can contain a DVD player that accesses viewable movie trailer information stored on a DVD. Other alternatives of media device 200 can include a removable storage device, such as a CF-card, a memory stick, a palm memory and/or a smart memory.

In an alternative exemplary embodiment, media device 200 includes an identifying device 204, such as a scanable bar code or a low-powered transmitter that is used by a master terminal device for accessing the viewable trailer information. The master terminal device transmits the viewable movie trailer information to media device 200 through an interface, such as an infrared (IR) link or a low-power radio frequency (RF) link. Alternatively, the master terminal device accesses the viewable trailer information and displays the trailer information on a display that is separate from media device 200. For this exemplary alternative embodiment, media device 200 does not include display 201.

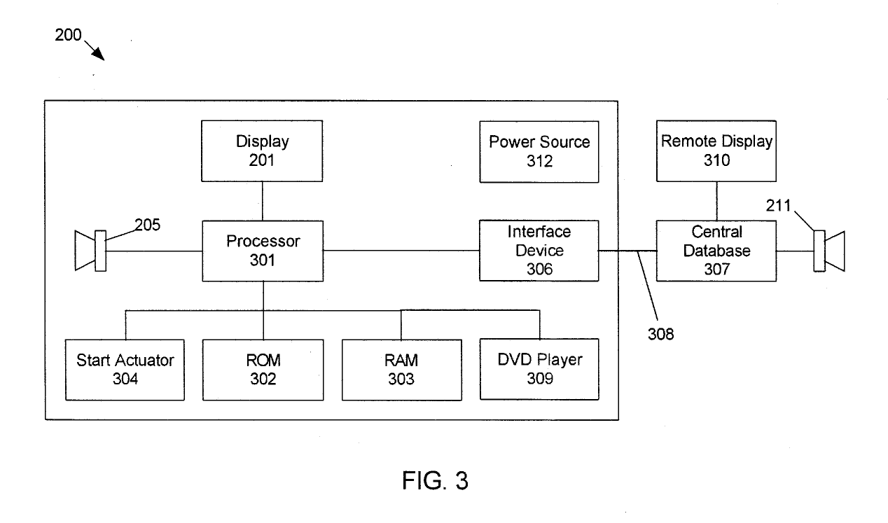

FIG. 3 shows an exemplary functional block diagram of the exemplary embodiment of a media device 200 according to the subject matter disclosed herein. As shown in FIG. 3, media device 200 includes a processor 301, such as a microprocessor or a microcontroller, a read-only memory (ROM) 302, a random access memory (RAM) 302, a start actuator 304, and an audio output device 305, such as a speaker. Processor 301, ROM 302, RAM 303, start actuator 304 and audio output device 305 are connected together and communicate in a well-known manner. ROM 302 contains control information used by processor 301 for displaying a movie trailer on display 201 in a well-known manner. ROM 302 can also contain viewable trailer information. Alternatively, RAM 303 can contain viewable trailer information. Start actuator 304 can be a motion sensor causes processor 301 to begin displaying trailer information on display 201 when start actuator 304 senses movement of display container 200. Alternatively, start actuator 304 can be a button, like button 203 shown in FIG. 2, that causes processor 301 to begin displaying trailer information on display 201 when start actuator 304 is depressed. The audio content of the viewable trailer information is output to audio output device 305.

Media device 200 can include an interface device 306 through which viewable trailer information can be loaded into RAM 303 or programmed into ROM 302 in a well-known manner. Interface device 306 can be, for example, a connector for a serial or a parallel data link connection, an IR interface and/or a low-powered RF link. Interface device 306 interfaces media device 200 to a central database 307 through a communication link 308 in a well-known manner, such as a protocol that is based on IEEE 802.11a/b/g protocol, a Bluetooth protocol and/or a packet-based protocol. Central database 307 contains a database of viewable movie trailer information that can be selected and loaded into the memory of media device 200. Media device 200 can contain software stored in, for example, ROM 302, that processor 301 executes automatically in response to interface device 306 sensing a connection to or a communication link with central database 307 to update viewable movie trailer information stored in the memory of media device 200. Alternatively, media device 200 can include a switch (not shown) that is accessible only by authorized persons and that causes processor 301 to update viewable movie trailer information stored in the memory of media device 200 through interface device 306.

Alternatively or in addition, media device 200 can include a DVD player 309 that plays a DVD containing viewable movie trailer information, such as a DVD for a particular movie. For this alternative embodiment, ROM 302 contains software that is executed by processor 301 that accesses only the viewable movie trailer information stored on the DVD. For yet another alternative embodiment, DVD player 309 accesses a DVD containing only viewable movie trailer information for a particular movie or for a plurality of movies.

Media device 200 includes a power supply 312 that supplies power to the various components forming the system of display container 200. Power supply 312 can be a battery-powered supply and/or can be powered from, for example, a 120 V AC power supply. Alternatively, power supply 312 can be solar cell connected to a rechargeable battery. As yet another alternative, power supply 312 can include an interface (not shown) that may use optical, inductive, capacitive and/or radio frequency coupling for receiving energy from a remote power source (not shown) in a well-known manner.

When media device 200 does not include a display 201, interface device 306 can be a scanable image, such as a barcode or a UPC-type code, that identifies a particular movie trailer stored in central database 307 and which is then displayed on a remote display 3 10. Audio content is output by audio output device 311. Alternatively, remote display 310 can be one of a plurality of remote terminals (not shown) that are distributed around a video rental store or a retail store, in which case there would be a plurality of interfaces couple to the central database 307 through which interface device 306 on media device 200 would communicate. The selected viewable movie trailer information would be directed by central database 307 to the appropriate remote video terminal in a well-known manner.

The media device of the subject matter disclosed herein is not limited to displaying viewable trailer information that is contained on or associated with DVDs, but can also display viewable trailer information that is contained on or associated with VCR tapes. In such a configuration, DVD player 309 would be replaced by a VCR player. For a configuration in which display container 200 presents audio content, DVD player 309 would be replaced by, for example, a CD player and/or an audio tape player.

Further, the media device of the subject matter disclosed herein is not limited to displaying viewable movie trailer information, but can display product information for a selected product or service. In such a configuration, the display container of the subject matter disclosed herein would be placed in proximity of a product and/or service retail display so that a potential purchaser could view specialized information relating to the product and/or service. Additionally, a media device according to the subject matter disclosed herein can also be used to provide information about a transportation system, such as route, scheduling, fare and safety information for bus lines, train lines, airplanes, ferries and taxis. For example, a passenger who is unfamiliar with a metropolitan transportation system can purchase a ticket for transportation between two points within the transportation system. The ticket can contain bar code information or information that can be conveyed via well-known RF-ID techniques that identifies the origin and desired destination of the traveler. The traveler can then bring the ticket into proximity with a consumer portable media device according to the subject matter disclosed herein that may be located, for example, on a bus or in a subway car, to initiate a start event. In response, the portable media device displays transit information for the traveler, such as connection information and/or scheduling information, so that the traveler can know which stop to exit to catch a connecting bus or subway train.

Additionally or in the alternative, the consumer portable media device can be used to provide transportation system infrastructure-based information to a traveler. For example, a traveler, who desires to attend a cultural event, such as a concert or a movie, could initiate a start event at a consumer portable media device that is part of the transportation system. The traveler could enter information, such as the traveler's origin and the time of the cultural event. The consumer portable media device provides the traveler with the optimum transportation route to timely arrive at the desired event, including, for example, how many blocks to walk a particular direction, then how many blocks to walk in another particular direction to arrive at the desired destination. The purchased ticket would contain the traveler's information that relates to the desired travel information and could then be used to initiate a start event when the ticket is placed in proximity to a portable media device within the transit system. Because the information provided to the traveler is infrastructure based, it can be automatically updated when there are known delays within the system. Accordingly, if there is a known delay that can be scheduled around, the system would provide such information to the traveler so that the traveler could arrive at the cultural event in a timely manner.

Another exemplary use for the consumer portable media device could be at places such as airports. A traveler arriving at a connection airport would initiate a start event using, for example, a ticket or a boarding pass. The consumer portable media device would then provide airport infrastructure-based information to the traveler for directing the traveler to the correct gate for making a connection, a map and the optimum route to get to the connecting gate. The subject matter disclosed herein could similarly be used at train and bus stations.

Further still, the media device of the subject matter disclosed herein is not limited to displaying or presenting video information. In the situation that the informational content is audio, such as an audio tape or CD, then the media device of the subject matter disclosed herein presents the audio content stored in the memory of the display container or stored on a tape or CD that is contained within display container. Alternatively, the media device of the subject matter disclosed herein can present a Braille representation of requested information to a user.

Although the foregoing subject matter has been described in some detail for purposes of clarity of understanding, it will be apparent that certain changes and modifications may be practiced that are within the scope of the appended claims. Accordingly, the present embodiments are to be considered as illustrative and not restrictive, and the subject matter disclosed herein is not to be limited to the details given herein, but may be modified within the scope and equivalents of the appended claims.

What is claimed is:

1. A media device, comprising:
a media output device; and
a controller coupled to the media output device, the controller accessing predetermined media content in response to a start event and causing the media output device to output the predetermined media content.

2. The media device according to claim 1, wherein the media output device is a display and the predetermined media content is viewable information.

3. The media device according to claim 2, wherein the viewable information is a movie trailer.

4. The media device according to claim 2, wherein the viewable information is information relating to at least one of a product and a service.

5. The media device according to claim 1, wherein the predetermined media content is transportation system infrastructure-based information.

6. The media device according to claim 1, wherein the media output device is an audio output device and the predetermined media content is audio information.

7. The media device according to claim 6, wherein the audio output device is a speaker.

8. The media device according to claim 6, wherein the audio output device is a pair of headphones.

9. The media device according to claim 1, wherein the media output device is a Braille output device.

10. The media device according to claim 1, wherein the audio information one of music, information relating to a product and information relating to a service.

11. The media device according to claim 1, further comprising a DVD player coupled to and controlled by the controller, the DVD player accessing the predetermined media content contained on a DVD under control of the controller.

12. The media device according to claim 1, further comprising a VCR player coupled to and controlled by the controller, the VCR player accessing the predetermined media content contained on a VCR tape under control of the controller.

13. The media device according to claim 1, further comprising an audio CD player coupled to and controlled by the controller, the audio CD player accessing the predetermined media content contained on an audio CD under control of the controller.

14. The media device according to claim 1, further comprising an audio tape player coupled to and controlled by the controller, the audio tape player accessing the predetermined media content contained on an audio tape under control of the controller.

15. The media device according to claim 1, further comprising a memory storing the predetermined media content.

16. The media device according to claim 15, wherein the memory is at least one of a hard disk drive, a flash memory, a random access memory and a read-only memory.

17. The media device according to claim 15, wherein the memory is at least one of a CD-flash card, a memory stick, a palm memory, a smart memory a CD-ROM and a DVD-ROM.

18. The media device according to claim 15, further comprising an interface device coupled to the controller, the predetermined media content being received through the interface device and being stored in the memory under control of the controller.

19. The media device according to claim 18, wherein the predetermined media content is received using a protocol that is based on an IEEE 802.11a/b/g protocol.

20. The media device according to claim 18, wherein the predetermined media content is received using a protocol that is based on a Bluetooth protocol.

21. The media device according to claim 18, wherein the predetermined media content is received using a packet-based protocol.

22. The media device according to claim 1, wherein the start event is movement of the display container being sensed by the controller.

23. The media device according to claim 1, wherein the start event is actuation of a button coupled to the controller.

24. The media device according to claim 1, wherein the start event is sensed by one of a heat, a motion and a light sensor.

25. The media device according to claim 1, wherein the start event is a touch to a touch screen device.
